(19) United States
(12) Patent Application Publication
(10) Pub. No.: US 2017/0372239 A1
(43) Pub. Date: Dec. 28, 2017

(54) Food Monitoring System

(71) Applicant: International Business Machines Corporation, Armonk, NY (US)

(72) Inventors: Michael Bender, Rye Brook, NY (US); Rhonda L. Childress, Austin, TX (US); David B. Kumhyr, Austin, TX (US); Michael J. Spisak, East Northport, NY (US)

(21) Appl. No.: 15/190,388

(22) Filed: Jun. 23, 2016

(51) Int. Cl. G06Q 10/06; G06F 17/30; G06Q 50/12

(52) U.S. Cl. CPC G06Q 10/0633; G06F 17/30312; G06Q 50/12

(57) ABSTRACT

A system, method, and computer program product for monitoring food in a restaurant system. The method receives, by a computer system, first data from a sensor system associated with a number of pieces of tableware. The first data describes the food on the number of pieces of tableware sent out for consumption by customers in the restaurant system. Further, the method receives, by the computer system, second data from the sensor system when the number of pieces of tableware is returned from the customers. The second data describes the food remaining on the number of pieces of tableware. Still further, the method identifies, by the computer system, an amount of the food wasted by the customers using the first data and the second data, enabling adjusting an operation of the restaurant system based on an amount of the food wasted.

### CROSS-REFERENCE TO RELATED APPLICATION

This application is related to the following U.S. patent application Ser. No. ______, attorney docket no. AUS920160321US1, filed even date herewith, and entitled “Monitoring System for Food Consumption,” which is incorporated herein by reference in its entirety.

### BACKGROUND

### 1. Field

The present disclosure relates generally to an improved food monitoring system and, in particular, to a method and apparatus detecting food consumption in a restaurant system using a food monitoring system. Still more particularly, the present disclosure relates to a method and apparatus for managing food in a restaurant system using sensors.

### 2. Description of the Related Art

Currently, food in restaurants is tracked. For example, shipments of food received by a restaurant may be logged into an inventory system for the restaurant and placed into storage. Inventories may be performed to see how much of the food remains in the storage. This information may be compared to sales of the food used in menu items in the restaurant. This information may be used to manage food purchases and the menu items offered by the restaurant to customers.

Currently used inventory systems provide information about food currently in storage, food used, and food discarded. This information may be used to manage food purchases, food preparation, and menu items offered by the restaurant. Although these food inventory systems may generally provide information about food usage in the restaurant, a level of detail of the information may not be as accurate as desired to optimize the operation of the restaurant.

### SUMMARY

The different illustrative embodiments provide a system, method, and computer program product for monitoring food in a restaurant system. The method receives, by a computer system, first data from a sensor system associated with a number of pieces of tableware. The first data describes the food on the number of pieces of tableware sent out for consumption by customers in the restaurant system. Further, the method receives, by the computer system, second data from the sensor system when the number of pieces of tableware is returned from the customers. The second data describes the food remaining on the number of pieces of tableware. Still further, the method identifies, by the computer system, an amount of the food wasted by the customers using the first data and the second data, enabling adjusting an operation of the restaurant system based on an amount of the food wasted.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of a block diagram of a food sensor environment in accordance with an illustrative embodiment;

FIG. 2 is an illustration of a block diagram of a sensor system in accordance with an illustrative embodiment;

FIG. 3 is an illustration of a block diagram of dataflow for analyzing data about food consumption in a restaurant system in accordance with an illustrative embodiment;

FIG. 4 is an illustration of a flowchart of a process for monitoring food in a restaurant system in accordance with an illustrative embodiment;

FIG. 5 is an illustration of a more detailed flowchart of a process for monitoring food in a restaurant system in accordance with an illustrative embodiment; and

FIG. 6 is an illustration of a block diagram of a data processing system in accordance with an illustrative embodiment.

### DETAILED DESCRIPTION

The illustrative embodiments recognize and take into account one or more different considerations. The illustrative embodiments recognize and take into account that current food inventory systems track food in storage such as in refrigerators, freezers, and other locations. The illustrative embodiments recognize and take into account that the amount of food entering the storage and leaving the storage is tracked. The illustrative embodiments also recognize and take into account that these food inventory systems do not track the food that customers consume within the restaurant. For example, the illustrative embodiments recognize and take into account that currently used food inventory systems do not track what types of food and how much of those types of food are consumed by the customers in the restaurant.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may run entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may run the computer readable program instructions by utilizing state information of the computer readable program instructions to personalize the electronic circuitry, in order to perform aspects of the present invention.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer readable program instructions.

These computer program instructions may be provided to a processor of a general purpose computer, special purpose computer, or other programmable data processing apparatus to produce a machine, such that the instructions, which run via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which run on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be run substantially concurrently, or the blocks may sometimes be run in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The illustrative embodiments recognize that it would be desirable to have a method and apparatus that take into account at least some of the issues discussed above, as well as other possible issues. For example, the illustrative embodiments recognize and take into account that it would be desirable to have a method and apparatus that overcome a technical problem with tracking food consumption by customers in a restaurant.

Thus, the illustrative embodiments provide a method and apparatus for tracking food consumption in a restaurant system. In one illustrative example, a food monitoring system comprises a number of pieces of tableware, a sensor system, and a food analyzer. The sensor system monitors food on the number of pieces of tableware and generates data about the food on the number of pieces of tableware. The food analyzer is configured to receive first data from the sensor system in which the first data describes the food on the number of pieces of tableware sent out for consumption by customers in a restaurant system and receive second data from the sensor system when the number of pieces of tableware is returned from the customers in which the second data describes the food remaining on the number of pieces of tableware. The food analyzer is also configured to identify an amount of the food wasted by the customers using the first data and the second data, enabling adjusting an operation of the restaurant system based on the amount of the food wasted.

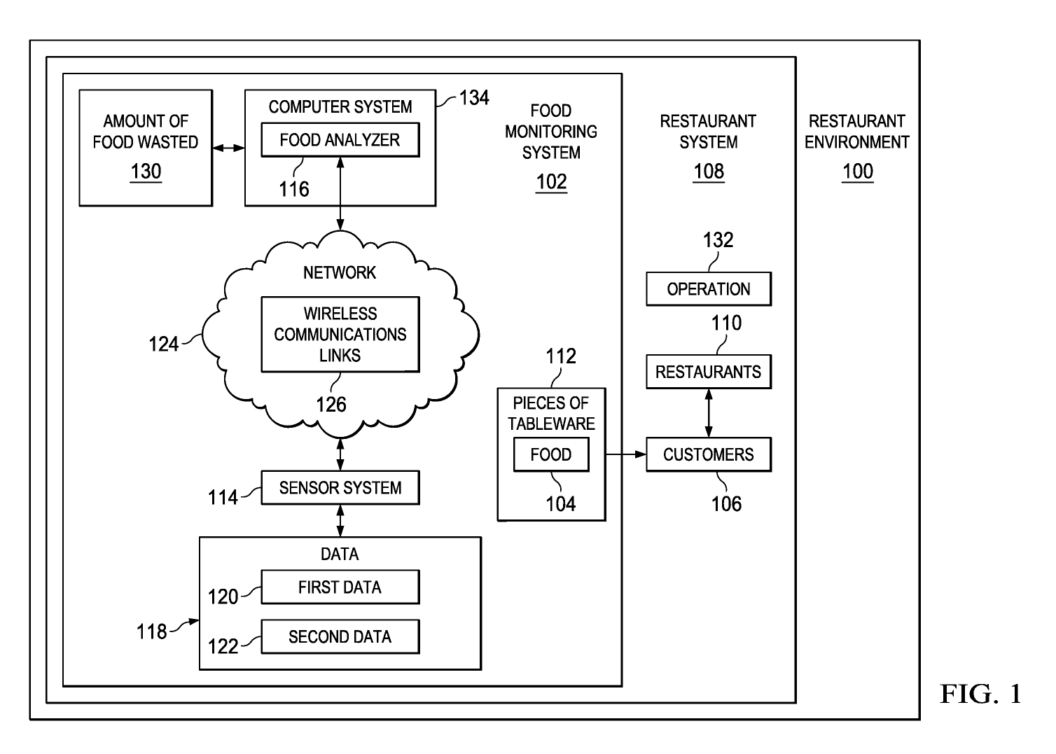

With reference now to the figures and, in particular, with reference to FIG. 1, an illustration of a block diagram of a food sensor environment is depicted in accordance with an illustrative embodiment. As depicted, restaurant environment 100 includes food monitoring system 102 that operates to monitor consumption of food 104 by customers 106 in restaurant system 108. In this illustrative example, restaurant system 108 includes a group of restaurants 110 in addition to food monitoring system 102.

As used herein, “a group of”, when used with reference to items, means one or more items. For example, “a group of restaurants 110” is one or more of restaurants 110.

In this illustrative example, food monitoring system 102 includes a number of different components. As depicted, food monitoring system 102 comprises a number of pieces of tableware 112, sensor system 114, and food analyzer 116. As used herein, “a number of”, when used with reference to items, means one or more items. For example, “a number of pieces of tableware 112” is one or more pieces of tableware 112.

The number of pieces of tableware 112 is physical structures that are designed to hold food 104. The number of pieces of tableware 112 includes, for example, at least one of a dish, a plate, a bowl, a cup, or other suitable structures that are used to hold food 104 for customers 106 of restaurant system 108.

As used herein, the phrase “at least one of”, when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item B. This example also may include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

Sensor system 114 monitors food 104 present on the number of pieces of tableware 112. Sensor system 114 generates data 118 about food 104 that is present on the number of pieces of tableware 112.

In this illustrative example, sensor system 114 is physically associated with the number of pieces of tableware 112. For example, a first component, such as a sensor system, may be considered to be physically associated with a second component, such as the number of pieces of tableware 112, by at least one of being secured to the second component, bonded to the second component, mounted to the second component, welded to the second component, fastened to the second component, or connected to the second component in some other suitable manner. The first component also may be connected to the second component using a third component. The first component may also be considered to be physically associated with the second component by being formed as part of the second component, an extension of the second component, or both.

During operation of food monitoring system 102 in restaurant system 108, sensor system 114 generates first data 120 in data 118 when food 104 is sent to customers 106 for consumption in restaurant system 108. For example, first data 120 is information about food 104 that is sent to customers 106.

Sensor system 114 generates second data 122 in data 118 when the number of pieces of tableware 112 is returned from customers 106. Second data 122 describes food 104 that remains on the number of pieces of tableware 112 after customers 106 are done consuming food 104.

As depicted, food analyzer 116 is in communication with sensor system 114 using network 124. As depicted, network 124 includes wireless communications links 126. For example, sensor system 114 may transmit data 118 over wireless communications links 126. Wireless communications links 126 may be implemented using any available wireless technology such as, for example, WiFi, Bluetooth, or other suitable types of wireless technologies for exchanging data 118.

Food analyzer 116 is configured to receive first data 120 from sensor system 114 in which first data 120 describes food 104 on the number of pieces of tableware 112 sent out for consumption by customers 106 in restaurant system 108. As depicted, food analyzer 116 is configured to receive second data 122 from sensor system 114 when the number of pieces of tableware 112 is returned from customers 106 in which second data 122 describes food 104 remaining on the number of pieces of tableware 112.

Further, food analyzer 116 is configured to identify amount of food wasted 130 by customers 106 using first data 120 and second data 122. In this manner, food monitoring system 102 enables adjusting operation 132 of restaurant system 108 based on amount of food wasted 130. Adjusting operation 132 comprises adjusting operation 132 of the group of restaurants 110 and may include at least one of selecting a different vendor, changing a recipe, adjusting a portion size, changing an ingredient, changing an item on the menu, customizing the menu for a customer, or other suitable changes. In addition, these different adjustments may be made for different periods of time such as for a lunch service, a dinner service, a weekday, a weekend day, a particular holiday, or some other suitable period of time.

Food analyzer 116 may be implemented in software, hardware, firmware, or a combination thereof. When software is used, the operations performed by food analyzer 116 may be implemented in program code configured to run on hardware, such as a processor unit. When firmware is used, the operations performed by food analyzer 116 may be implemented in program code and data and stored in persistent memory to run on a processor unit. When hardware is employed, the hardware may include circuits that operate to perform the operations in food analyzer 116.

In the illustrative examples, the hardware may take a form selected from at least one of a circuit system, an integrated circuit, an application specific integrated circuit (ASIC), a programmable logic device, or some other suitable type of hardware configured to perform a number of operations. With a programmable logic device, the device may be configured to perform the number of operations. The device may be reconfigured at a later time or may be permanently configured to perform the number of operations. Programmable logic devices include, for example, a programmable logic array, a programmable array logic, a field programmable logic array, a field programmable gate array, and other suitable hardware devices. Additionally, the processes may be implemented in organic components integrated with inorganic components and may be comprised entirely of organic components, excluding a human being. For example, the processes may be implemented as circuits in organic semiconductors.

As depicted, food analyzer 116 is located in computer system 134. Computer system 134 is a physical hardware system and includes one or more data processing systems. When more than one data processing system is present, those data processing systems are in communication with each other using a communications medium. The communications medium may be a network. The data processing systems may be selected from at least one of a computer, a server computer, a tablet, or some other suitable data processing system.

In the illustrative example, one or more technical solutions are present that overcome a technical problem with tracking food consumption by customers in a restaurant. As a result, one or more technical solutions may provide a technical effect of identifying food 104 consumed by customers 106, food 104 not consumed by customers 106, or some combination thereof. With this information, amount of food wasted 130 may be identified in order to perform operation 132 for restaurant system 108.

As a result, computer system 134 operates as a special purpose computer system in which food analyzer 116 in computer system 134 enables identifying amount of food wasted 130 by customers 106. In particular, food analyzer 116 transforms computer system 134 into a special purpose computer system as compared to currently available general computer systems that do not have food analyzer 116.

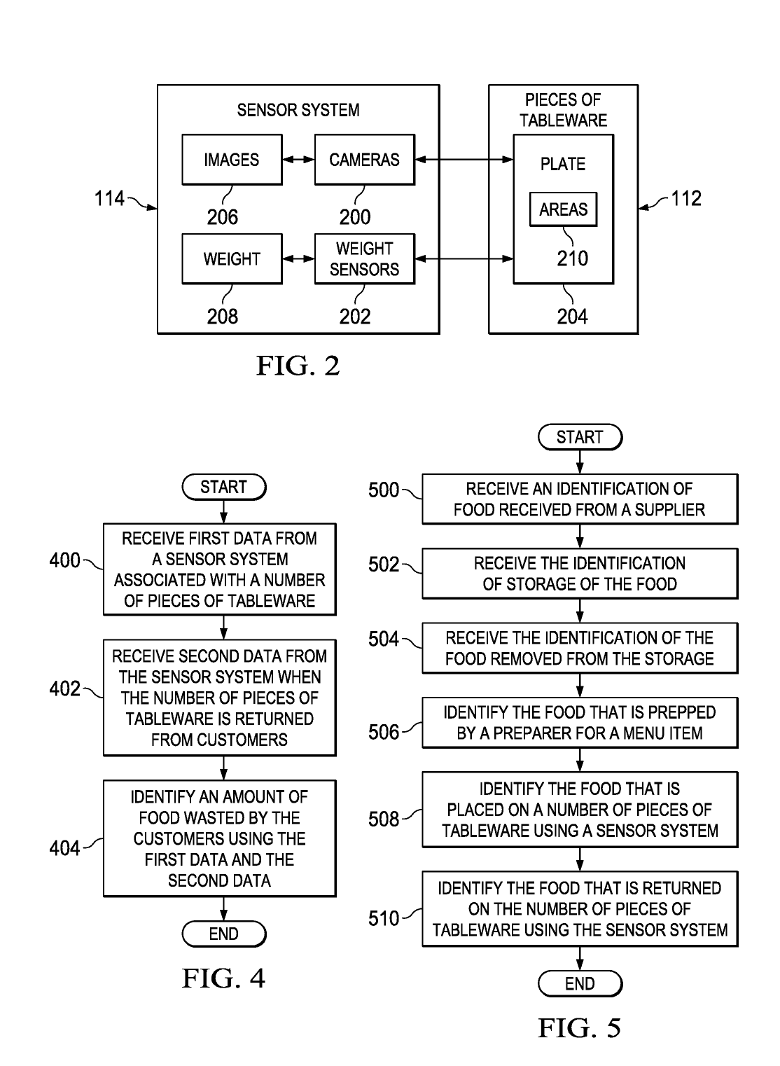

Turning now to FIG. 2, an illustration of a block diagram of a sensor system is depicted in accordance with an illustrative embodiment. An example of one implementation for sensor system 114 in FIG. 1 is shown in this figure.

In this figure, sensor system 114 comprises cameras 200 and weight sensors 202. As depicted, a number of cameras 200 in plate 204 in a number of pieces of tableware 112 generates images 206 of food 104 in FIG. 1 on plate 204. A number of weight sensors 202 may identify weight 208 of food 104.

Images 206 may be processed using object recognition techniques to identify types of food 104 in FIG. 1 present on plate 204. The types of food 104 may be selected, for example, from at least one of a meat, such as steak, ribs, or fish; a vegetable, such as carrots, broccoli, a baked potato, or mashed potatoes; bread, soup, or other suitable types of food 104.

In this example, weight 208 may be identified for each of a number of areas 210 on plate 204 on which a type of food 104 in FIG. 1 is located. In other words, weight 208 of each type of food 104 may be identified in areas 210 where each type of food 104 is present on plate 204. In this manner, weight 208 may be identified for each type of food 104 on plate 204.

In the illustrative example, the number of cameras 200 and the number of weight sensors 202 physically associated with plate 204 are used to generate first data 120 in FIG. 1, which describes the number of types of food 104 and the amount of the number of types of food 104 sent to a customer on plate 204. Further, the number of cameras 200 and the number of weight sensors 202 are used to generate second data 122, which describes the remaining types of food 104 and a remaining amount of the number of types of food 104 present on plate 204 when returned by customers 106.

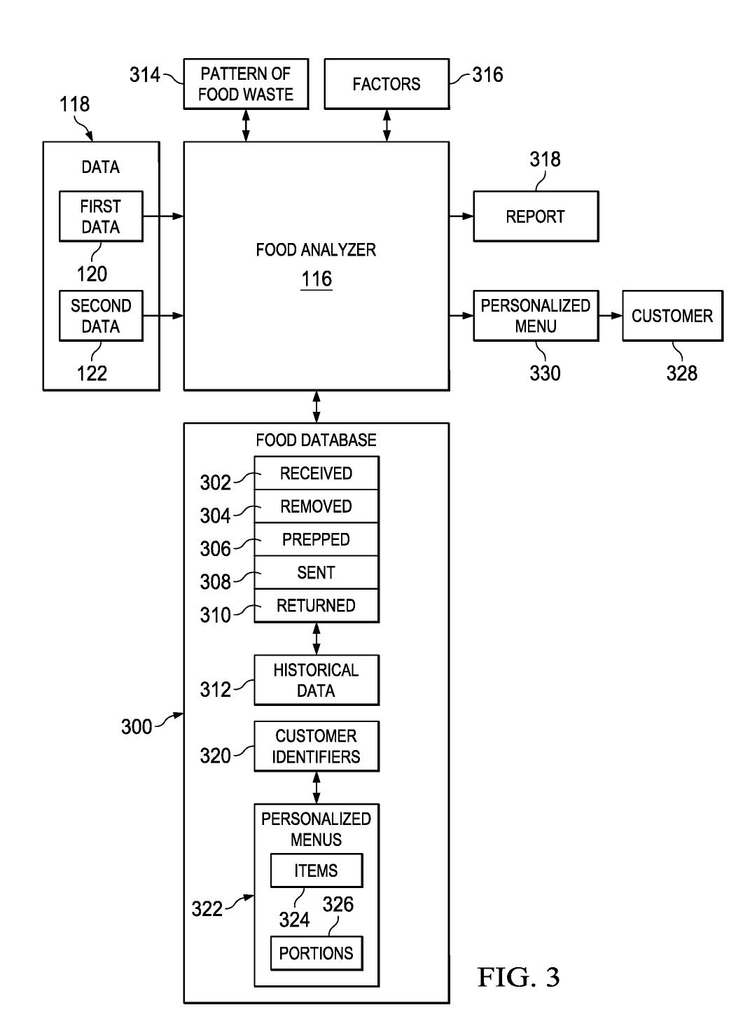

With reference now to FIG. 3, an illustration of a block diagram of dataflow for analyzing data about food consumption in a restaurant system is depicted in accordance with an illustrative embodiment. As depicted, food analyzer 116 is configured to monitor use of food 104 in restaurant system 108 in FIG. 1. For example, food analyzer 116 may be used to analyze food 104 in one or more of restaurants 110 in FIG. 1.

Food analyzer 116 stores data 118 about food 104 in FIG. 1 in food database 300. As depicted, the amount of food 104 identified as being wasted is entered into food database 300 for restaurant system 108 in FIG. 1.

Food analyzer 116 stores information about food 104. The types of information may include at least one of received 302, removed 304, prepped 306, sent 308, and returned 310.

In this illustrative example, received 302 identifies food 104 received and placed into storage along with a date of receipt. Removed 304 identifies food 104 removed from storage. Food 104 may be removed from storage for a number of different reasons. For example, food 104 may be removed for preparation for a customer, discarded because food 104 is spoiled past its expiration date, transferred to another restaurant in restaurant system 108 in FIG. 1, or for some other suitable reason. Prepped 306 identifies food 104 that is prepared for consumption by customers 106 in FIG. 1.

In this example, sent 308 describes food 104 sent on the number of pieces of tableware 112 to customers 106. Sent 308 may be identified using first data 120. As depicted, returned 310 describes food 104 returned by customers 106 after being sent to customers 106. Returned 310 may be identified using second data 122. In this illustrative example, the description of food 104 may include the types of food 104 and the amount of each type of food 104.

As depicted, sent 308 and returned 310 recorded over time form historical data 312 that may be used to identify a pattern, a trend, or other information about amount of food wasted 130 in FIG. 1. Food analyzer 116 identifies amount of food wasted 130 using sent 308, and returned 310 is identified using first data 120 and second data 122.

Food analyzer 116 may identify a group of factors 316 affecting the food waste using food database 300. In this illustrative example, a factor in the group of factors 316 is a factor that affects how much of food 104 is consumed or wasted by customers 106 in FIG. 1. As depicted, the group of factors 316 is selected from at least one of a preparer, a recipe, a time between preparation and serving, a source of an ingredient for food 104, a temperature of food 104, a serving size, quality of an ingredient, freshness of an ingredient, or some other suitable factor. Operation 132 of restaurant system 108 in FIG. 1 may be adjusted by the group of factors 316.

With this analysis, food analyzer 116 may generate report 318. Report 318 may include information about factors 316. Report 318 may identify trends, outliers, averages, and other information. Further, report 318 also may provide recommendations selected from at least one of reviewing a portion size, changing individual items, reviewing vendors of food 104, or other recommendations. As a result, adjusting operation 132 of restaurant system 108 is enabled using the group of factors 316 identified.

Further, sent 308 and returned 310 in food database 300 may also be associated with customers 106 in FIG. 1 using customer identifiers 320. In this manner, the consumption of food 104 may be identified for each of customers 106. This information may be used to identify customer preferences with respect to food 104.

Customer identifiers 320 also may be associated with personalized menus 322. Personalized menus 322 are generated based on the identification of sent 308 and returned 310 for customers 106. Based on at least one of food 104 consumed or food 104 not consumed, as identified by sent 308 and returned 310, personalized menus 322 may be created for customers 106. Personalized menus 322 may include customizations of items 324 and portions 326. Likes and dislikes are identified based on identifying pattern of food waste 314 in historical data 312 for customers 106.

For example, customer 328 in customers 106 in FIG. 1 is identified when customer 328 visits the group of restaurants 110 in restaurant system 108 in FIG. 1. Food analyzer 116 identifies personalized menu 330 in personalized menus 322 for customer 328. Further, personalized menu 330 may be refined over time for customer 328 based on updates to sent 308 and returned 310 for customer 328.

In the illustrative example, personalized menu 330 may be provided to customer 328 in a number of different ways. For example, a paper menu may be printed for customer 328 each time customer 328 visits the group of restaurants 110 in FIG. 1. As another example, a menu may be provided to customer 328 on a tablet computer which has personalized menu 330 downloaded onto the tablet computer for customer 328. In this manner, each customer may have a personalized menu.

Thus, food database 300 may use food analyzer 116 to identify at least one of taste, dietary restrictions, seasonal religious observations, or other factors for customer 328. Additionally, food database 300 also may be configured to receive input from customer 328. This input may be to preferences received directly from customer 328 in addition identifying preferences based on sent 308 and returned 310 in food database 300. The additional input may be obtained from a loyalty sign-up program, previous selections of menu items, or other suitable sources.

The illustrations of restaurant environment 100 and the different components in restaurant environment 100 in FIGS. 1-3 are not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, when multiple restaurants are present in the group of restaurants 110, the identification of the amount of food wasted 130 may be performed for each of restaurants 110 individually and for restaurants 110 as a group. Further, restaurants 110 may all serve the same type of cuisine or different types of cuisine in restaurant system 108.

Turning next to FIG. 4, an illustration of a flowchart of a process for monitoring food in a restaurant system is depicted in accordance with an illustrative embodiment. The process illustrated in FIG. 4 is implemented in restaurant environment 100 in FIG. 1. One or more of the different steps may be implemented in food analyzer 116 in FIG. 1 and FIG. 3.

The process begins by receiving first data from a sensor system associated with a number of pieces of tableware (step 400). The first data describes food on the number of pieces of tableware sent out for consumption by customers in a restaurant system. The process receives second data from the sensor system when the number of pieces of tableware is returned from customers (step 402). The second data describes the food remaining on the number of pieces of tableware.

The process identifies an amount of food wasted by the customers using the first data and the second data (step 404) with the process terminating thereafter. The process in this figure enables adjusting an operation of the restaurant system based on the amount of the food wasted.

With reference now to FIG. 5, an illustration of a more detailed flowchart of a process for monitoring food in a restaurant system is depicted in accordance with an illustrative embodiment. The process illustrated in FIG. 5 may be implemented in food analyzer 116 in FIG. 1 and FIG. 3. The information identified in this flowchart may be stored in food database 300 in FIG. 3.

The process begins by receiving an identification of food received from a supplier (step 500). Next, the process receives the identification of storage of the food (step 502). In step 502, the identification of the food being placed into storage may include information selected from at least one of an identification of the food, a supplier identifier, amounts of the food, a date received, an expiration date, a “use by” date, or other suitable information.

The process receives the identification of the food removed from the storage (step 504). Then, the process identifies the food that is prepped by a preparer for a menu item (step 506). The identification also may include identifying the preparer. The process identifies the food that is placed on a number of pieces of tableware using a sensor system (step 508). The process identifies the food that is returned on the number of pieces of tableware using the sensor system (step 510) with the process terminating thereafter.

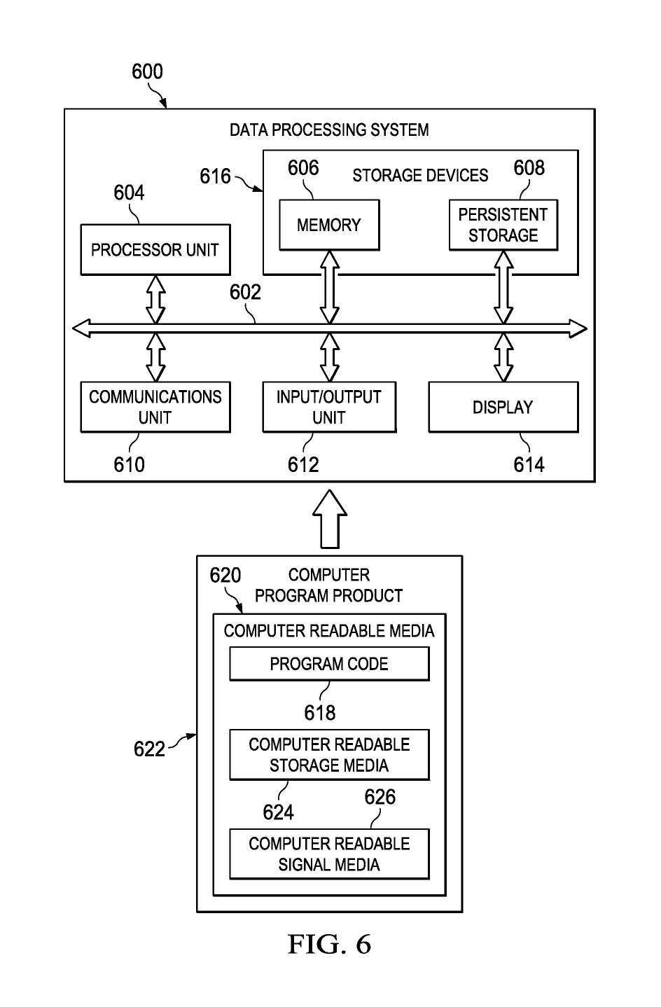

Turning now to FIG. 6, an illustration of a block diagram of a data processing system is depicted in accordance with an illustrative embodiment. Data processing system 600 may be used to implement computer system 134 in FIG. 1. In this illustrative example, data processing system 600 includes communications framework 602, which provides communications between processor unit 604, memory 606, persistent storage 608, communications unit 610, input/output (I/O) unit 612, and display 614. In this example, communications framework 602 may take the form of a bus system.

Processor unit 604 serves to run instructions for software that may be loaded into memory 606. Processor unit 604 may be a number of processors, a multi-processor core, or some other type of processor, depending on the particular implementation.

Memory 606 and persistent storage 608 are examples of storage devices 616. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 616 may also be referred to as computer readable storage devices in these illustrative examples. Memory 606, in these examples, may be, for example, a random access memory or any other suitable volatile or non-volatile storage device. Persistent storage 608 may take various forms, depending on the particular implementation.

For example, persistent storage 608 may contain one or more components or devices. For example, persistent storage 608 may be a hard drive, a solid state hard drive, a flash memory, a rewritable optical disk, a rewritable magnetic tape, or some combination of the above. The media used by persistent storage 608 also may be removable. For example, a removable hard drive may be used for persistent storage 608.

Communications unit 610, in these illustrative examples, provides for communications with other data processing systems or devices. In these illustrative examples, communications unit 610 is a network interface card.

Input/output unit 612 allows for input and output of data with other devices that may be connected to data processing system 600. For example, input/output unit 612 may provide a connection for user input through at least one of a keyboard, a mouse, or some other suitable input device. Further, input/output unit 612 may send output to a printer. Display 614 provides a mechanism to display information to a user.

Instructions for at least one of the operating system, applications, or programs may be located in storage devices 616, which are in communication with processor unit 604 through communications framework 602. The processes of the different embodiments may be performed by processor unit 604 using computer-implemented instructions, which may be located in a memory, such as memory 606.

These instructions are referred to as program code, computer usable program code, or computer readable program code that may be read and run by a processor in processor unit 604. The program code in the different embodiments may be embodied on different physical or computer readable storage media, such as memory 606 or persistent storage 608.

Program code 618 is located in a functional form on computer readable media 620 that is selectively removable and may be loaded onto or transferred to data processing system 600 for execution by processor unit 604. Program code 618 and computer readable media 620 form computer program product 622 in these illustrative examples. In one example, computer readable media 620 may be computer readable storage media 624 or computer readable signal media 626. In these illustrative examples, computer readable storage media 624 is a physical or tangible storage device used to store program code 618 rather than a medium that propagates or transmits program code 618.

Alternatively, program code 618 may be transferred to data processing system 600 using computer readable signal media 626. Computer readable signal media 626 may be, for example, a propagated data signal containing program code 618. For example, computer readable signal media 626 may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

The different components illustrated for data processing system 600 are not meant to provide architectural limitations to the manner in which different embodiments may be implemented. The different illustrative embodiments may be implemented in a data processing system including components in addition to or in place of those illustrated for data processing system 600. Other components shown in FIG. 6 can be varied from the illustrative examples shown. The different embodiments may be implemented using any hardware device or system capable of running program code 618.

Thus, one or more of the illustrative examples provide a method and apparatus for analyzing food consumption by customers in a restaurant. As depicted in the illustrative examples, an amount of food wasted by customers may be detected using a sensor system associated with a number of pieces of tableware. Data generated by the sensor system may be used to identify the food not consumed by the customers. In this manner, adjustments to the operation of the restaurant may be made to decrease the amount of food wasted.

Food monitoring system 102, comprising food analyzer 116 and sensor system 114 associated with the number of pieces of tableware 112 in FIG. 1, may be used to identify numerous situations in which the wasted food in a restaurant may be reduced. For example, a restaurant serves a high-end steak with a traditional creamed spinach side. The steak is a restaurant favorite, but upon further analysis of the returned food remaining on the plates for this menu item, food analyzer 116 in food monitoring system 102 identifies that 90% of customers ordering the steak did not touch the creamed spinach based on the amount of food returned and detected on the returned plates. As a result, a change in this menu item was tested in which the creamed spinach was replaced with corn. With the change, the plates were returned with less food and customer comment cards showed increased customer satisfaction. This change in the operation of the restaurant leads to increased customer satisfaction while reducing food waste.

As another illustrative example, a pasta restaurant offers a family-sized pasta. Analysis of this menu item using food monitoring system 102 in FIG. 1 identifies that 100% of the plates are returned with at least 20% of the pasta. As a result, an adjustment may be made to reduce portion size, thus reducing costs of the restaurant for purchasing of the pasta and disposing of waste.

In another illustrative example, a restaurant prepares much of its food in the morning. Fried chicken is one of the big sellers every week for the restaurant. An analysis of the food using food monitoring system 102 in FIG. 1 shows that larger amounts of the fried chicken are eaten at lunch than at dinner, though the portion sizes are the same. Also, a majority of the fried chicken is ordered from the lunch menu. With the analysis provided using food monitoring system 102, the restaurant decides that they need to either prepare the fried chicken fresh for dinner or remove the item from the dinner menu.

In yet illustrative another example, a bar offers many different styles of chicken wings. Upon analysis using food monitoring system 102 in FIG. 1, 15% of the chicken wings using one wing sauce always has a high number of chicken wings left. With this information, input from customers is obtained from the customers and a determination is made that the chicken wings are spicier than anticipated, and that particular offering is moved to the “hot wings” section of the menu from the “mild wings” section. With this change in the organization of the menu, a reduction in the number of customers ordering that sauce occurs, but only 2% of the plates have a high number of chicken wings being returned.

In a further illustrative example, a restaurant traditionally has 8% of its chocolate cake. A trend has been identified where 20% of the chocolate cake is being returned. This change in the amount of chocolate cake being returned coincides with an additional vendor supplying some of the chocolate cake. An analysis of the information shows that the returns are all coming from an additional vendor of the chocolate cake. The restaurant switches back to the original vendor which improves customer satisfaction, as shown by the trend returning to only 8% of the chocolate cake being returned.

In another illustrative example, a family frequently travels on the same cruise line that has switched from paper menus to tablets. The cruise line cross references their orders with what they consume using food monitoring system 102 in FIG. 1. Over time, the cruise line modifies what the front page of the menu displays after establishing that one parent likes steak with French fries over mashed potatoes; the other parent prefers rib roast over chicken; and the daughter is a vegetarian. While the other items are available, those items can be prioritized in a less prominent location in the menu. In addition, recommended wines are adjusted to what the adults drink with a meal as opposed to what is traditionally ordered using pieces of tableware that include cups associated with a sensor system. This leads to a change in the operation that results in increased customer satisfaction and decreased waste elimination costs.

In still another illustrative example, a restaurant identifies inconsistent returns on the mashed potatoes using food monitoring system 102 in FIG. 1. Upon analysis of the mashed potatoes wasted, the returns are related to the mashed potatoes made by a recently hired chef who is not following the standard recipe. The change in the operation in this example is instructing the new chef to use the standard recipe. The change results in food monitoring system 102 identifying that the returns of the mashed potatoes are reduced to levels normally expected.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

The different illustrative examples describe components that perform actions or operations. In an illustrative embodiment, a component may be configured to perform the action or operation described. For example, the component may have a configuration or design for a structure that provides the component an ability to perform the action or operation that is described in the illustrative examples as being performed by the component.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A food monitoring system comprising:
a number of pieces of tableware;
a sensor system physically associated with the number of pieces of tableware, wherein the sensor system monitors food on the number of pieces of tableware; and
a food analyzer in a computer system configured to receive first data from the sensor system in which the first data describes the food on the number of pieces of tableware sent out for consumption by customers in a restaurant system; receive second data from the sensor system when the number of pieces of tableware is returned from the customers in which the second data describes the food remaining on the number of pieces of tableware; and identify an amount of the food wasted by the customers using the first data and the second data, enabling adjusting an operation of the restaurant system based on the amount of the food wasted.

2. The food monitoring system of claim 1 further comprising:
storing the amount of the food identified as being wasted in a food database for the restaurant system.

3. The food monitoring system of claim 2 further comprising:
identifying a group of factors affecting the food wasted using the food database.

4. The food monitoring system of claim 3 further comprising:
adjusting the operation of the restaurant system using the group of factors identified.

5. The food monitoring system of claim 3, wherein the group of factors is selected from at least one of a preparer, a recipe, a time between preparation and serving, a source of an ingredient for the food, a temperature of the food, or a serving size.

6. The food monitoring system of claim 1, wherein the first data comprises a number of types of the food and the amount of a number of types of the food.

7. The food monitoring system of claim 1, wherein the second data comprises a remaining amount of a number of types of the food on the number of pieces of tableware.

8. The food monitoring system of claim 1, wherein the sensor system comprises cameras and weight sensors associated with the number of pieces of tableware.

9. A method for monitoring food in a restaurant system, the method comprising:
receiving, by a computer system, first data from a sensor system associated with a number of pieces of tableware, wherein the first data describes the food on the number of pieces of tableware sent out for consumption by customers in the restaurant system;
receiving, by the computer system, second data from the sensor system when the number of pieces of tableware is returned from the customers, wherein the second data describes the food remaining on the number of pieces of tableware; and
identifying, by the computer system, an amount of the food wasted by the customers using the first data and the second data, enabling adjusting an operation of the restaurant system based on the amount of the food wasted.

10. The method of claim 9 further comprising:
storing, by the computer system, the amount of the food identified as being wasted in a food database for the restaurant system.

11. The method of claim 10 further comprising:
identifying, by the computer system, a group of factors affecting the food wasted using the food database.

12. The method of claim 11 further comprising:
adjusting the operation of the restaurant system using the group of factors identified.

13. The method of claim 11, wherein the group of factors is selected from at least one of a preparer, a recipe, a time between preparation and serving, a source of an ingredient for the food, a temperature of the food, or a serving size.

14. The method of claim 9, wherein the first data comprises a number of types of the food and the amount of the number of types of the food.

15. The method of claim 9, wherein the second data comprises a remaining amount of a number of types of the food on the number of pieces of tableware.

16. The method of claim 9, wherein the sensor system comprises cameras and weight sensors associated with the number of pieces of tableware.

17. A computer program product for monitoring food in a restaurant system, the computer program product comprising:
a computer readable storage media;
first program code, stored on the computer readable storage media, executable by a processor unit to cause the processor unit to receive first data from a sensor system associated with a number of pieces of tableware, wherein the first data describes the food on the number of pieces of tableware sent out for consumption by customers in the restaurant system;
second program code, stored on the computer readable storage media, executable by the processor unit to cause the processor unit to receive second data from the sensor system when the number of pieces of tableware is returned from the customers, wherein the second data describes the food remaining on the number of pieces of tableware; and
third program code, stored on the computer readable storage media, executable by the processor unit to cause the processor unit to identify an amount of the food wasted by the customers using the first data and the second data, enabling adjusting an operation of the restaurant system based on the amount of the food wasted.

18. The computer program product of claim 17 further comprising:
fourth program code, stored on the computer readable storage media, executable by the processor unit to cause the processor unit to store the amount of the food identified as being wasted in a food database for the restaurant system; and
fifth program code, stored on the computer readable storage media, executable by the processor unit to cause the processor unit to identify a group of factors affecting the food wasted using the food database, wherein the group of factors is selected from at least one of a preparer, a recipe, a time between preparation and serving, a source of an ingredient for the food, a temperature of the food, or a serving size.

19. The computer program product of claim 18 further comprising:
sixth program code, stored on the computer readable storage media, executable by the processor unit to cause the processor unit to identify the group of factors affecting the food wasted using the food database.

20. The computer program product of claim 19, wherein the group of factors is selected from at least one of the preparer, the recipe, the time between preparation and serving, the source of the ingredient for the food, the temperature of the food, or the serving size.
